(19) United States
(12) Patent Application Publication
(10) Pub. No.: US 2008/0311243 A1
(43) Pub. Date: Dec. 18, 2008

(54) High Viscosity Beta Glucan Products And Methods of Preparation

(76) Inventors: Thavaratnam Vasanthan, Edmonton (CA); Feral Temelli, Edmonton (CA); Beljit Ghotra, Edmonton (CA); Mohamed Khan, Edmonton (CA)

Correspondence Address: ST. ONGE STEWARD JOHNSTON & REENS, LLC, 986 BEDFORD STREET, STAMFORD, CT, 06905-5619, US

(21) Appl. No.: 12/138,919

(22) Filed: Jun. 13, 2008

Related U.S. Application Data
(60) Provisional application No. 60/943,753, filed on Jun. 13, 2007.

(51) Int. Cl. C12C 1/073

(52) U.S. Cl. 426/28

(57) ABSTRACT

The invention describes improved methods of preparing high concentration and high viscosity beta-glucan concentrates. More specifically, the invention describes methods wherein beta-glucan is concentrated from bran, whole grain and endosperm flours through various slurrying steps in a high concentration alcohol media utilizing various combinations of enzyme and alkali treatment steps.

### CROSS-REFERENCE TO RELATED APPLICATIONS

This application claims the benefit of priority from U.S. provisional application 60/943,753 filed Jun. 13, 2007.

### FIELD OF THE INVENTION

The invention describes improved methods of preparing high concentration and high viscosity beta-glucan concentrates. More specifically, the invention describes methods wherein beta-glucan is concentrated from bran, whole grain and endosperm flours through various slurrying steps in a high concentration alcohol media utilizing various combinations of enzyme and alkali treatment steps.

### BACKGROUND OF THE INVENTION

Plant materials including grains contain a number of valuable components such as starch, protein, mixed linkage 1-4, 1-3 beta-D-glucan (hereinafter “β-glucan”, “beta-glucan” or “BG”), cellulose, pentosans, lipids, tocols, etc. These components, and products derived from these components have many food and non-food uses. Consequently, there is a strong and continued industry interest for the processing of such plant materials.

Oat and barley beta-glucan is a soluble fiber component. It is a viscous polysaccharide made up of D-glucose sugar units. Oat and barley beta-glucan is comprised of mixed-linkage polysaccharides. This means that the bonds between the D-glucose or D-glucopyranosyl units are either beta-1, 3 linkages or beta-1, 4 linkages. This type of beta-glucan is also referred to as a mixed-linkage (1→3), (1→4)-beta-D-glucan.

Dietary fiber is generally accepted as having protective effects against a range of diseases predominant in developed countries including colorectal cancer, coronary heart disease, diabetes, obesity, and diverticular disease. The term “dietary fiber” is commonly defined as plant material that resists digestion by the secreted enzymes of the human alimentary tract but may be fermented by the microflora in the colon. Increased fiber consumption is associated with lowering total serum cholesterol and LDL cholesterol, modifying the glycemic and insulinemic response, protecting the large intestine from disease and immune system enhancement. BG, a non-starch polysaccharide, is a water-soluble component of dietary fiber and thus contributes to such health benefits.

Generally, it is believed that consumption of beta-glucan increases the viscosity of intestinal contents, thus slowing down the movement of dietary cholesterol and glucose as well as bile acids towards the intestinal walls leading to reduced absorption. These benefits have led to the U.S. Food and Drug Administration (FDA) approving a health claim indicating that four daily servings of oat and barley products containing 0.75 grams/serving of soluble fiber (beta-glucan) may reduce the risk of heart disease.

Cardio-Vascular Disease (CVD) is considered the principal cause of death in all developed countries, being responsible for 20% of deaths worldwide. In the United States 59.7% of people had some form of CVD in 1997, and in Canada, 8 million people are estimated to be suffering from CVD. An estimated 102 million American adults have total blood cholesterol levels of 200 milligrams per deciliter (mg/dL) and higher. Of these, about 41 million have levels of 240 mg/dL or above. In adults, total cholesterol levels of 240 mg/dL or higher are considered high risk. Levels from 200 to 239 mg/dL are considered borderline high risk. Low-density lipoprotein (LDL) cholesterol levels of 130 mg/dL or higher is associated with increased risk of coronary heart disease and occurs in approximately 45% of Americans. Approximately 18% of Americans have LDL cholesterol levels of 160 mg/dL or higher. High LDL cholesterol levels are associated with a higher risk of coronary heart disease (CHD).

Not only is CVD the number one cause of death, it also is the most expensive disease in most developed countries (See “Economic Costs of Cardiovascular Diseases” American Heart Association, 2002. 2002 Heart and Stroke Statistical Update). In the U.S. in 2002, the disease cost was $329.2 billion in direct and indirect costs. Direct costs were $199.5 billion, with drug costs totaling $31.8 billion. Canadian cost statistics (1993) indicate total CVD costs as $19.7 billion. Direct costs amounted to $7.3 billion, with drugs accounting for $1.6 billion of this total. These statistics demonstrate the importance of reducing the risk of CVD through dietary means. Increased consumption of soluble fiber, especially through the incorporation of beta-glucan as an ingredient into a variety of food products can contribute significantly towards this goal. However, it is crucial for the beta-glucan to have high-viscosity characteristics to achieve the claimed health benefits since there is growing evidence that links health benefits of beta-glucan to its viscosity.

Until now, BG has been restricted to high value markets such as cosmetics, medical applications, and health supplements due to the high cost of extraction, which, as a result has prohibited its use as an ingredient in the food industry. Current food products in the marketplace contain low concentrations of BG, requiring consumption of unrealistic amounts of such products on a daily basis in order to achieve the health benefits.

In an effort to concentrate BG from grains, a number of investigations at laboratory and pilot scale have been carried out on the fractionation of these grains including barley and oats. In general, conventional processes utilize water, acidified water and/or aqueous alkali (i.e. NaOH, Na₂CO₃ or NaHCO₃) as solvents for the slurrying of whole cracked barley, barley meal (milled whole barley) or barley flour (roller milled barley flour or pearled-barley flour) as well as similar oat products. These slurries, in which the BG is solubilized, are then processed by techniques such as filtration, centrifugation and ethanol precipitation to separate the slurry into various components. This conventional process for barley/oat fractionation has a number of technical problems and whilst realizing limited commercial feasibility has been limited by the expense of the product particularly for food applications.

In particular, technical problems arise because the beta-glucan in barley or oat flour, for example, is an excellent water-binding agent (a hydrocolloid) and as such, upon addition of water (neutral, alkali or acidic environment), the beta-glucan hydrates and tremendously thickens (increases the viscosity) the slurry. This thickening imposes many technical problems in the further processing of the slurry into fractions enriched in starch, protein and fiber, including clogging of the filter during filtration and inefficient separation of flour components during centrifugation.

Usually, these technical problems are minimized, if not eliminated, by the addition of a substantial quantity of water to the thick/viscous slurry in order to dilute and bring the viscosity down to a level where further processing can be carried out. However, the use of high volumes of water leads to several further problems including increased effluent water volumes and the resulting increased disposal costs. In addition, the beta-glucan, which solubilizes and separates with the supernatant (water) during centrifugation, is usually recovered by precipitation with ethanol. This is done by the addition of an equal volume of absolute ethanol into the supernatant. After the separation of precipitated beta-glucan, the ethanol is preferably recovered for recycling. However, recovery requires distillation, which is also a costly operation from an energy usage perspective.

Furthermore, the aqueous alkali solubilization and subsequent precipitation of beta-glucan in ethanol (and centrifugation steps in between) is known to contribute to the breakdown of the beta-glucan chains that result in a lower-grade, lower-viscosity beta-glucan product.

Still further, the use of these past techniques also is believed to support both the growth of microorganisms and increased enzyme activity that may contribute to hydrolysis of the beta-glucan chains. These problems are particularly manifested in larger batch operations where it may become difficult to control enzyme activity and thus lead to problems in achieving batch-to-batch consistency.

Accordingly, there is a need for efficient processes for the fractionation of grains that overcome the particular problems of slurry viscosity and water usage. Moreover, there is a need for a process that provides a high purity, high-viscosity beta-glucan product in a close to natural state (i.e. high viscosity) wherein the BG product has low starch and protein content.

In Applicant's co-pending applications U.S. application Ser. No. 10/380,739 and U.S. application Ser. No. 10/397,215, techniques for concentrating high quality beta-glucan are described utilizing the flour of the endosperm fraction of grains as a starting material for extraction. Applicant's past methodologies taught the use of concentrating BG in a concentrated alcohol media where BG was not solubilized and precipitation of BG was not required. In addition, Applicant's previous technologies also taught the use of protease and amylase enzymes in a concentrated alcohol media to reduce protein and starch contents within the beta-glucan concentrate product. While these past methodologies have been effective in producing high quality and high yield beta-glucan, there continues to be a need for additional or further beta glucan concentration technologies where the cost and efficiencies of producing high concentration BG continues to be improved.

As noted above, Applicant's past techniques have taught the use of the flour of endosperm portion of grains. In the past, the use of the bran portion of grains has been considered to be problematic for the production of high quality BG due to the perceived difficulty in concentrating BG from the bran because the BG is embedded within the cellulose matrix of the bran and hence more difficult to separate. As a result, past concentration methodologies, including Applicant's past technologies focused on the concentration of BG from the flour of the endosperm portion of grain.

However, from a cost perspective, there is interest in being able to utilize all components of a grain including bran, whole grain flour and endosperm flours as a starting material for BG concentration.

As a result, there continues to be a need for methodologies that improve the yield, concentration and quality of beta-glucan products concentrated from the cell walls of grains including oats and barley that overcome problems of water-based extraction techniques. In addition, there continues to be a need for extraction techniques to improve the commercial cost of concentrating beta-glucan.

### SUMMARY OF THE INVENTION

In accordance with the invention, there is provided a method of concentrating beta-glucan (BG) from a grain material comprising the steps of: a) mixing the grain material and a 40-100% (v/v) aqueous alcohol to form a grain/aqueous alcohol slurry and incubating the grain/aqueous alcohol slurry with a xylanase, amylase or protease and thereafter separating a first fiber residue; b) mixing the first fiber residue with a 40-100% (v/v) aqueous alcohol at a high pH to form a second fiber residue/aqueous-alcohol slurry and thereafter separating a second fiber residue from the second fiber residue/aqueous-alcohol slurry; c) mixing the second fiber residue with a 40-100% (v/v) aqueous alcohol to form a third fiber residue/aqueous-alcohol slurry and thereafter separating a final fiber residue from the third fiber residue/aqueous-alcohol slurry.

In further embodiments, the final fiber residue has a BG concentration greater than 40%, 45%, 50% or 55% (dry basis).

In another embodiment, step a) is repeated with a xylanase, amylase or protease before or after step b) wherein the xylanase, amylase or protease used in the repeated step a) is a different enzyme to that used in step a).

In another embodiment, the invention further comprises at least one pre-wash step prior to step a), the pre-wash step comprising mixing the grain material with a 40-100% (v/v) aqueous alcohol to form a grain/aqueous alcohol slurry and separating a fiber residue from the grain/aqueous alcohol slurry as the starting grain material for step a). The pre-wash steps may be repeated.

In further embodiments, one or more post wash steps may be conducted after step c), the post-wash step comprising mixing a separated fiber residue from step c) with a 40-100% (v/v) aqueous alcohol to form a further fiber residue/aqueous alcohol slurry and thereafter separating a further final fiber residue from the further fiber residue/aqueous alcohol slurry, wherein the further final fiber residue has a BG concentration greater than 40% (dry basis).

In a preferred embodiment, the grain material is any one of or a combination of bran, endosperm flour or whole grain flour. In another embodiment, the bran is an oat bran having a total beta-glucan content of at least 5.5% (dry weight basis).

In yet another embodiment, prior to step a), the bran is subjected to a preliminary enrichment process wherein the total beta-glucan content is raised to at least 10% (by weight). The preliminary enrichment process may be an air classification process.

In various embodiments, the final fiber residue has a protein concentration less than 3% (by weight) and/or a pentosan concentration less than 40% (by weight).

Preferably, the viscosity of the final fiber residue when dissolved in water (0.5% beta-glucan, w/w) is greater than 120 cP at a shear rate of 129 s⁻¹ at 20° C.

In another embodiment, the order of steps a) and b) are reversed.

In yet another embodiment, the ratio of grain material/fiber residue to aqueous alcohol is 1 part (by weight) of grain material/fiber residue to >2 parts (by volume) of 50% (v/v) aqueous ethanol.

In a more specific embodiment, the invention provides a method of concentrating beta-glucan (BG) from bran comprising the steps of:
a. mixing bran having an initial beta-glucan content of at least 5% (dry weight basis) and a concentrated aqueous alcohol to form a first slurry;
b. separating a first fiber residue from the first slurry;
c. mixing the first fiber residue and a concentrated aqueous alcohol to form a second slurry;
d. separating a second fiber residue from the second slurry;
e. mixing the second fiber residue and a concentrated aqueous alcohol to form a third slurry;
f. separating a third fiber residue from the third slurry;
g. mixing the third fiber residue with concentrated aqueous alcohol and amylase to form a fourth fiber slurry and incubating the fourth fiber slurry for a time sufficient for the amylase to reduce starch content in the third fiber residue;
h. inactivating the amylase by adjusting the pH of the fourth fiber slurry to an acidic pH.
i. adjusting the pH of the fourth fiber slurry to a neutral pH and separating a fourth fiber residue from the fourth fiber slurry;
j. mixing the fourth fiber residue with concentrated aqueous alcohol to form a fifth fiber slurry;
k. adjusting the pH of the fifth fiber slurry to a pH>11 and incubating the fifth fiber slurry for a time sufficient to reduce protein content in the fourth fiber residue; add acid to achieve a neutral pH adjusting the pH of the fifth fiber slurry to a neutral pH;
l. separating a fifth fiber residue from the fifth fiber slurry;
m. mixing the fifth fiber residue with concentrated aqueous alcohol to form a sixth fiber slurry;
n. separating a sixth fiber residue from the sixth fiber slurry;
o. mixing the sixth fiber residue with concentrated aqueous alcohol to form a seventh fiber slurry;
p. separating a final fiber residue from the seventh fiber slurry wherein the final fiber residue has a BG content greater than 45% (dry basis).

In yet another embodiment, the invention provides a method of concentrating beta-glucan (BG) from bran comprising the steps of:
a. mixing bran having an initial beta-glucan content of at least 5% (dry weight basis) and a concentrated aqueous alcohol to form a first slurry;
b. separating a first fiber residue from the first slurry;
c. mixing the first fiber residue and a concentrated aqueous alcohol to form a second slurry;
d. separating a second fiber residue from the second slurry;
e. mixing the second fiber residue and a concentrated aqueous alcohol to form a third slurry;
f. separating a third fiber residue from the third slurry;
g. mixing the third fiber residue with concentrated aqueous alcohol and protease to form a fourth fiber slurry and incubating the fourth fiber slurry for a time sufficient for the protease to reduce protein content in the third fiber residue;
h. separating a fourth fiber residue from the fourth fiber slurry;
i. mixing the fourth fiber residue with concentrated aqueous alcohol and amylase to form a fifth fiber slurry and incubating the fifth fiber slurry for a time sufficient for the amylase to reduce starch content in the fourth fiber residue;
j. inactivating the amylase by adjusting the pH of the fifth fiber slurry to an acidic pH;
k. adjusting the pH of the fifth fiber slurry to a neutral pH and separating a fifth fiber residue from the fifth fiber slurry;
l. mixing the fifth fiber residue with concentrated aqueous alcohol, adjusting the pH of the sixth fiber slurry to a pH>11 and incubating the sixth fiber slurry for a time sufficient to reduce protein content in the fifth fiber residue and adjusting the pH of the sixth fiber slurry to a neutral pH;
m. separating a sixth fiber residue from the sixth fiber slurry;
n. mixing the sixth fiber residue with concentrated aqueous alcohol to form a seventh fiber slurry;
o. separating a final fiber residue from the seventh fiber slurry wherein the final fiber residue has a final BG concentration greater than 45% (dry basis).

In yet another embodiment, the invention provides a method of concentrating beta-glucan (BG) from bran comprising the steps of:
a. mixing bran having an initial beta-glucan content of at least 5% (dry weight basis) and a concentrated aqueous alcohol to form a first slurry;
b. separating a first fiber residue from the first slurry;
c. mixing the first fiber residue and a concentrated aqueous alcohol to form a second slurry;
d. separating a second fiber residue from the second slurry;
e. mixing the second fiber residue and a concentrated aqueous alcohol to form a third slurry;
f. separating a third fiber residue from the third slurry;
g. mixing the third fiber residue with concentrated aqueous alcohol and xylanase to form a fourth fiber slurry and incubating the fourth fiber slurry for a time sufficient for the xylanase to reduce xylan content in the third fiber residue;
h. separating a fourth fiber residue from the fourth fiber slurry
i. mixing the fourth fiber residue with concentrated aqueous alcohol and amylase to form a fifth fiber slurry and incubating the fifth fiber slurry for a time sufficient for the amylase to reduce starch content in the fourth fiber residue;
j. inactivating the amylase by adjusting the pH of the fifth fiber slurry to an acidic pH;
k. adjusting the pH of the fifth fiber slurry to a neutral pH and separating a fifth fiber residue from the fifth fiber slurry;
l. mixing the fifth fiber residue with concentrated aqueous alcohol to form a sixth fiber slurry, adjusting the pH of the sixth fiber slurry to a pH>11 and incubating the sixth fiber slurry for a time sufficient to reduce protein content in the fifth fiber residue; adjusting the pH of the sixth fiber slurry to a neutral pH;
m. separating a sixth fiber residue from the sixth fiber slurry;
n. mixing the sixth fiber residue with concentrated aqueous alcohol to form a seventh fiber slurry;
o. separating a final fiber residue from the seventh fiber slurry wherein the final fiber residue has a final BG concentration greater than 45% (dry basis)

### BRIEF DESCRIPTION OF THE DRAWINGS

The invention is described in part with reference to the accompanying drawing in which:

FIG. 1 is a graph showing the incremental increase in BG concentration through successive wash, enzyme and alkali treatment steps in accordance with one embodiment of the invention.

### DETAILED DESCRIPTION OF THE INVENTION

In accordance with the invention and with reference to the FIGURE, embodiments of improved processes for concentrating beta-glucan from grain materials are described.

Overview

The present technology is contrasted with Applicant's past BG concentration techniques by:
a. conducting portions of the process at high alkali pH (preferably greater than 11);
b. incorporating the use of additional enzymes including xylanase; and,
c. utilizing any one of or a combination of bran, whole grain flour and endosperm flour as a starting material.

### DEFINITIONS

In this description, the following definitions for bran, whole grain flour and endosperm flour that have been derived from cereal grain are utilized. A cereal grain is usually described as having 4 major grain parts including the husk/hull, bran, germ (i.e. embryo) and endosperm (i.e. storage organ that contains starch, protein, etc.).

“Whole grain flour” generally refers to dehulled grains (i.e. after the removal of the fibrous husk/hull) that have been reduced in particle size by grinding or milling.

“Bran” generally refers to a blend primarily comprised of the seed coat, aleurone and sub-aleurone layers of a cereal grain that have been reduced in particle size by grinding or milling. However, due to the difficulties in precise separation of the grain tissues, commercially available bran is usually contaminated to a certain extent with germ and endosperm.

“Endosperm flour” generally refers to flour derived primarily from the endosperm portion of a cereal grain.

More specifically, in the context of this description, oat bran (as endorsed by the American Association of Cereal Chemists) is defined as follows: “oat bran is the food which is produced by grinding clean oat groats or rolled oats and separating the resulting oat flour by sieving, bolting, and/or other suitable means into fractions such that the oat bran is not more than 50% of the original starting material and has a total beta-glucan content of at least 5.5% (dry-weight basis) and a total dietary fiber content of at least 16.0% (dry-weight basis), and such that at least one-third of the total dietary fiber is soluble fiber.”

Bran, while previously considered to be a commercially unacceptable starting material for the concentration of BGs as understood in Applicant's co-pending patent applications (incorporated herein by reference), in one series of experiments, the subject application investigated the use of bran as a commercially viable source of BG.

The following examples utilized oat bran as a starting material for BG concentration. Further experiments described below were also conducted in which whole grain flours and endosperm flours were used as a starting material for BG concentration. It is understood that bran from other grains, such as barley, may also be utilized as well as whole grain flour or endosperm flour from oats, barley or other suitable grains.

Oat bran as a starting material was prepared in accordance with the following general methodologies. Raw oats were de-hulled and the oat groats subjected to grinding and sieving to create oat bran in accordance with the preceding definition.

In the subject application, the BG concentration in the bran utilized in the following experiments was 10-16% (by weight). The starch concentration in the bran was 24-36 wt % compared to 60-65% (by weight) in the raw oats.

Air Classification

In various embodiments of the invention, the starting grain material may be further subjected to other preliminary concentrating steps such as air-classification to remove additional starch and thereby provide a preliminary concentrating effect of beta-glucan within the starting grain material.

For example, the bran may be processed to lower the starch concentration and increase the beta-glucan concentration relative to the starch and beta-glucan concentrations in the raw grain and meet the minimum BG concentration specified in the definition of bran.

Xylanase

Xylanases refer to a class of enzymes that are active in breaking down linear polysaccharide beta-1,4-xylan (also referred to pentosans, as they are made up of 5-carbon sugars) into shorter chain xylans and xylose depending on the reaction time. As a result, xylanases contribute to breaking down hemicellulose, which is a major component of the cell wall of plants.

### EXPERIMENTAL

The methodologies described herein generally include successive slurrying of a bran or fiber residue in a concentrated alcohol media (40-100% v/v, aqueous), enzyme incubation steps, alkali treatment steps and the separation of BG-enriched portions thereof. Within this description, all aqueous ethanol concentrations described herein refer to a v/v basis.

With regards to various experimental conditions, including specific concentrations of alcohol, incubation times, ratios of fiber residue to alcohol, reaction temperatures, pH values and screen sizes used in the various slurrying and separation steps in accordance with general methodology of the invention, it is understood to those skilled in the art that variation in one experimental parameter may require adjustment of another experimental parameter in order to achieve the objective of producing a high concentration BG product having a concentration of greater than 40% (dry basis), preferably greater than 45-50% and more preferably greater than 55%. As such, a worker of ordinary skill would understand that reasonable variation in the experimental conditions explicitly described herein would enable the objective of high concentration BG product without undue experimentation.

Slurrying and enzyme incubation steps were performed within a glass flask to simulate the reactors used for larger scale production. Separation was achieved by screening and was performed with a WS Tyler (CAN/CGSB-8.1) 75 μm screen using a WS Tyler RX-8/7-CAN vibrational screen instrument (Mentor, Ohio). The retentate obtained from successive screens generally contained concentrated BG fiber whereas the filtrate contained starch granules, dextrins, proteins and other solubilized components. The temperature and pH of the reaction mixtures were maintained using a LAUDA E100 water bath heater and ACCUMET auto temperature compensated pH meter, respectively. Heat stable-amylase was from Novozymes North America Inc., USA. Xylanase was from EDC, NY. BG content of samples was determined using BG assay kits obtained from Megazyme Inc. (Ireland).

Contents of moisture, beta glucan, starch, and protein (N×6.25) of dried samples were determined in duplicate according to the methods of AACC (1983), McCleary and Glennie-Holmes (1985), Holm et al. (1986) and FP-428 Nitrogen Determinator (Leco Corp., St. Joseph, Mich.), respectively. Lipid and pentosan content were determined according to the tests reported by AACC (1982) and Hashimoto et al., (1987).

For viscosity determinations, an appropriate amount of BG concentrate was solubilized in water at 85° C. for 1 hour to give a 0.5% (w/w) beta-glucan solution (dispersion). The dispersions were then allowed to cool down to room temperature followed by centrifugation to recover the clear supernatant that is collected for the viscosity determination. Viscosity was determined at consecutive fixed shear rates of 1.29-129 s⁻¹ (1-100 rpm) using a Paar Physica UDS 200 rheometer (Glenn, Va.). The viscometer was equipped with a Peltier heating system that controlled the sample temperature. All viscosity tests were performed at 20° C. using DG 27 cup and bob geometry using a 7±0.005 g sample.

The following experiments were conducted to investigate the effects of using bran as a starting material with and without various processing steps including amylase, xylanase, protease and alkali treatment steps to concentrate BG fiber.

### Example 1

This was the control experiment to the other experiments (Examples 2-6) of this study. In this example, oat bran was subjected to successive ethanol washing steps (i.e. slurrying and screening steps) without enzyme or alkali treatment, but only applying the identical temperature and mixing times used during the other experiments.

Specifically, oat bran (40 g) was slurried with 50% (v/v) aqueous ethanol at the ratio of 1 part (by weight) of bran to 5.3 parts (by volume) of 50% aqueous ethanol. The slurry was continuously mixed at room temperature (23° C.) for 30 minutes and was screened (Screen-1). The retentate of Screen-1 was collected and re-slurried in fresh 50% (v/v) aqueous ethanol at the ratio of 1 part (by weight) of starting bran to 2.1 parts (by volume) of 50% (v/v) aqueous ethanol. The slurry was subsequently mixed for 5 minutes at room temperature and was screened (Screen-2). The retentate of Screen-2 was re-slurried in fresh aqueous 50% ethanol at the ratio of 1 part (by weight) of starting bran to 2.1 parts (by volume) of 50% (v/v) aqueous ethanol. The slurry was mixed for 5 minutes at room temperature and screened (Screen-3). The retentate from Screen-3 was re-slurried in fresh 50% (v/v) aqueous ethanol at a ratio of 1 part (by weight) of starting bran to 2.1 parts (by volume) of 50% (v/v) aqueous ethanol. The temperature was increased to 80° C. and the mixture was held at 80° C. for 60 minutes. The mixture was then cooled to 35° C. and screened (Screen-4). The retentate from Screen-4 was re-slurried using fresh 50% (v/v) aqueous ethanol at a ratio of 1 part (by weight) of starting bran to 2.1 parts (by volume) of 50% (v/v) aqueous ethanol and the heat treatment was repeated. The mixture was then cooled to 35° C. and screened (Screen-5). The retentate of Screen-5 was re-slurried and mixed for 5 minutes with 50% (v/v) aqueous ethanol at a ratio of 1 part (by weight) of starting bran to 2.1 parts (by volume) of 50% (v/v) aqueous ethanol and screened (Screen-6). The retentate of Screen-6 was collected and re-slurried in fresh 50% (v/v) aqueous ethanol at a ratio of 1 part (by weight) of starting bran to 2.5 parts (by volume) of 50% (v/v) aqueous ethanol for 5 minutes and screened (Screen-7). The retentate of Screen-7 was then collected and dried at 70° C. for 12 hours.

### Example 2

In this example, the use of oat bran as a starting material and successive protease and amylase treatments was investigated.

Oat bran (40 g) and respective retentates were slurried with 50% (v/v) aqueous ethanol and screened as described in Example 1 for Screens 1-3. The retentate of Screen-3 was re-slurried in fresh 50% (v/v) aqueous ethanol at a ratio of 1 part (by weight) of starting bran to 2.1 parts (by volume) of 50% (v/v) aqueous ethanol. The pH of the slurry was adjusted to pH 6.5 and the temperature was maintained at room temperature for protease (Deerland Fungal protease) treatment for 2 hours. The slurry was then screened (Screen-4). The retentate from Screen-4 was re-slurried in fresh 50% (v/v) aqueous ethanol at a ratio of 1 part (by weight) of starting bran to 2.1 parts (by volume) of 50% (v/v) aqueous ethanol. The temperature was increased to 80° C. Calcium chloride (CaCl₂) (0.05%, w/w on starting bran basis) and 1.4% (w/w on starting bran basis) heat stable alpha-amylase were added and the reaction mixture was held at 80° C. for 60 minutes. The enzyme was inactivated by adjusting the pH to 3.5 with concentrated HCl for 10 minutes. The mixture was cooled to 35° C. and the solution was neutralized using NaOH and screened (Screen-5). The retentate of Screen-5 was re-slurried and mixed for 5 minutes with 50% (v/v) aqueous ethanol at a ratio of 1 part (by weight) of starting bran to 2.1 parts (by volume) of 50% (v/v) aqueous ethanol and screened (Screen-6). The retentate of Screen-6 was collected and re-slurried in fresh 50% (v/v) aqueous ethanol at a ratio of 1 part (by weight) of starting bran to 2.5 parts (by volume) of 50% (v/v) aqueous ethanol for 5 minutes and screened (Screen-7). The retentate of Screen-7 was then collected and dried at 70° C. for 12 hours.

### Example 3

In this experiment, the effect of replacing protease treatment with a xylanase treatment was investigated.

Oat bran (40 g) and respective retentates were slurried with 50% (v/v) aqueous ethanol and screened as described in Example 1 for Screens 1-3. The retentate of Screen-3 was re-slurried in fresh 50% (v/v) aqueous ethanol at a ratio of 1 part (by weight) of starting bran to 2.1 parts (by volume) of 50% (v/v) aqueous ethanol and the temperature was increased to 55° C. Xylanase was added (1%, w/w, bran basis) and the mixture was incubated for 1 hour. The mixture was then cooled to 35° C. and screened (Screen-4). The retentate from Screen-4 was subsequently treated as described above in Example 2 with the remaining amylase treatment and subsequent screens (Screens 5-7).

### Example 4

In this example, the use of oat bran as a starting material and successive amylase and alkali treatments were investigated.

Oat bran (40 g) and respective retentates were slurried with 50% (v/v) aqueous ethanol and screened as described in Example 1 for Screens 1-3. The retentate from Screen-3 was re-slurried in fresh 50% (v/v) aqueous ethanol at a ratio of 1 part (by weight) of starting bran to 1.5 parts (by volume) of 50% (v/v) aqueous ethanol. The temperature was increased to 80° C. Calcium chloride (CaCl₂) (0.05%, w/w on starting bran basis) and 1.4% (w/w on starting bran basis) heat stable alpha-amylase was added and the reaction mixture was held at 80° C. for 60 minutes. The enzyme was inactivated by adjusting the pH to 3.5 with concentrated HCl for 10 minutes. The mixture was cooled to 35° C. and the solution was neutralized using NaOH and screened (Screen-4). The retentate of Screen-4 was re-slurried in fresh 50% (v/v) aqueous ethanol at a ratio of 1 part (by weight) of starting bran to 2.1 parts (by volume) of 50% (v/v) aqueous ethanol, caustic was added at 60° C. and the temperature was increased to 80° C. The pH was maintained at 11.3 for 75 minutes and subsequently neutralized to pH 7.5 with HCl. The mixture was screened (Screen-5) and the retentate from Screen 5 was washed twice by slurrying and screening with 50% EtOH as described in Example 2 (Screens 6 and 7). The retentate of Screen-7 was finally collected and dried at 70° C. for 12 hours.

### Example 5

In this experiment, the effect of a post-enzyme (protease and amylase) alkali treatment step was investigated.

Oat bran (40 g) and respective retentates were slurried with 50% (v/v) aqueous ethanol and screened as described in Example 1 for Screens 1-3. The retentate of Screen-3 was subjected to successive protease and amylase treatments as described in Example 2 (Screens 4-5). The retentate of Screen-5 was re-slurried in fresh 50% (v/v) aqueous ethanol at a ratio of 1 part (by weight) of starting bran to 2.1 parts (by volume) of 50% (v/v) aqueous ethanol. Caustic was added at 60° C. and the temperature was increased to 80° C. The pH was maintained at 11.3 for 75 minutes and subsequently neutralized to pH 7.5 with HCl. The mixture was screened (Screen-6) and re-slurried in 50% EtOH at a ratio of 1 part (by weight) of retentate to 2.5 parts (by volume) aqueous ethanol and screened (Screen-7). The retentate of Screen-7 was finally collected and dried at 70° C. for 12 hours.

### Example 6

In this experiment, the effect of a post-enzyme (xylanase and amylase) alkali treatment step was investigated.

Oat bran (40 g) and respective retentates were slurried with 50% (v/v) aqueous ethanol as described in Example 1 for Screens 1-3. The retentate of Screen-3 was subjected to successive xylanase and amylase treatments as described in Example 3 (Screens 4-5). The retentate of Screen-5 was re-slurried in fresh 50% (v/v) aqueous ethanol at a ratio of 1 part (by weight) of starting bran to 2.1 parts (by volume) of 50% (v/v) aqueous ethanol. As in Example 4, caustic was added at 60° C. and the temperature was increased to 80° C. The pH was maintained at 11.3 for 75 minutes and subsequently neutralized to pH 7.5 with HCl. The mixture was screened (Screen-6) and re-slurried in 50% EtOH at a ratio of 1 part (by weight) of retentate to 2.5 parts (by volume) aqueous ethanol and screened (Screen-7). The retentate of Screen-7 was finally collected and dried at 70° C. for 12 hours.

Results and Discussion

The chemical composition (%, db) of the raw-material bran is as follows: beta-glucan 16.6%; protein 25.8%; starch 24.5%; pentosan 5.9%; and moisture 4.2%.

The results from Examples 1-6 are summarized in Table 1.

TABLE 1
Summary of product results^{a} from examples 1-6

| Example | | | | | | | |
|---|---|---|---|---|---|---|---|
| number and | | | BG | Starch | Protein | Pentosan | Viscosity |
| Treatment | Yield^{b} | BG^{c} | Recovery | removal | removal | removal | (cP) |
| steps | (%, db) | (%, db) | (%) | (%) | (%) | (%) | (@9129s⁻¹) |
| 1: Rigorous | 53.3 | 23.3 | 74.8 | 62.0 | 37.9 | 5.1 | 148 |
| Ethanol | | | | | | | |
| Washing | | | | | | | |
| 2: Protease- | 22.0 | 39.0 | 49.8 | 97.8 | 79.6 | 58.3 | 85 |
| Amylase | | | | | | | |
| 3: Xylanase- | 20.3 | 41.5 | 49.4 | 98.0 | 83.5 | 56.2 | 107 |
| Amylase | | | | | | | |
| 4: Amylase- | 14.8 | 55.8 | 47.9 | 98.4 | 97.8 | 62.7 | 139 |
| Alkali | | | | | | | |
| 5: Protease- | 13.0 | 58.7 | 44.7 | 99.0 | 97.9 | 71.4 | 135 |
| Amylase- | | | | | | | |
| Alkali | | | | | | | |
| 6: Xylanase- | 14.3 | 57.9 | 48.7 | 98.7 | 97.4 | 64.6 | 121 |
| Amylase- | | | | | | | |
| Alkali | | | | | | | |

^{a}Values are means of two replicates
^{b}Yield is based on the raw-material bran weight
^{c}BG = Beta-glucan

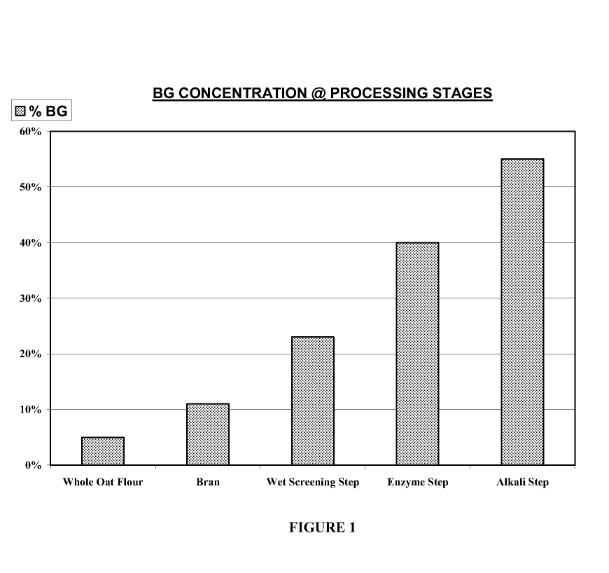

The cumulative effect of successive wash, enzyme and alkali treatments are shown in FIG. 1 on BG concentration after each treatment.

### Example 1

The dried product from Screen-7 had a total mass of 21.3 g (53.3% of the raw-material bran weight). As summarized in Table 1, the beta-glucan concentration was 23.3% (w/w, dry basis) of the total mass of the dried product. Beta-glucan recovery was 74.8% of the total beta-glucan in the bran. Starch removal was 62%, protein removal was 37.9% and pentosan removal was 5.1%. The aqueous viscosity of the dried beta-glucan product (the solution prepared at 0.5% (w/w) beta-glucan concentration) was 148 centipoises at a shear rate of 129 s⁻¹. The final concentrated beta-glucan product was a free flowing powder with fresh grain odor and color.

As a control, this example showed that rigorous washing in successive high concentration alcohol steps showed that a maximum BG concentration of 23.3 (w/w, dry basis) could be obtained.

### Example 2

The dried product from Screen-7 had a total mass of 8.8 g (22.0% of the raw-material bran weight). As summarized in Table 1, the beta-glucan concentration was 39.0% (w/w, dry basis) of the total mass of the dried product. Beta-glucan recovery was 49.8% of the total beta-glucan in the bran. Starch removal was 97.8%, protein removal was 79.6% and pentosan removal was 58.3%. The aqueous viscosity of the dried beta-glucan product (the solution prepared at 0.5% (w/w) beta-glucan concentration) was 85 centipoises at a shear rate of 129 s⁻¹. The lower viscosity may be attributed to the residual beta-glucanase activity in the fungal source protease used in the experiment. The final concentrated beta-glucan product was a free flowing powder with fresh grain odor and color.

### Example 3

The dried product from Screen-7 had a total mass of 8.1 g (20.3% of the raw-material bran weight). As summarized in Table 1, the beta-glucan concentration was 41.5% (w/w, dry basis) of the total mass of the dried product. Beta-glucan recovery was 49.4% of the total beta-glucan in the bran. Starch removal was 98.0%, protein removal was 83.5% and pentosan removal was 56.2%. The aqueous viscosity of the dried beta-glucan product (the solution prepared at 0.5% (w/w) beta-glucan concentration) was 107 centipoises at a shear rate of 129 s⁻¹. The final concentrated beta-glucan product was a free flowing powder with fresh grain odor and color.

Example 3 indicated that the effect of replacing protease treatment with a xylanase treatment made no substantial difference in the total recovery of BG or BG concentration within the final product but did moderately improve viscosity compared to Example 2.

### Example 4

The dried product from Screen-7 had a total mass of 5.9 g (14.8% of the raw-material bran weight). As summarized in Table 1, the beta-glucan concentration was 55.8% (w/w, dry basis) of the total mass of the dried product. Beta-glucan recovery was 47.9% of the total beta-glucan in the bran. Starch removal was 98.4%, protein removal was 97.8% and pentosan removal was 62.7%. The aqueous viscosity of the dried beta-glucan product (the solution prepared at 0.5% (w/w) beta-glucan concentration) was 139 centipoises at a shear rate of 129 s⁻¹.

Example 4 indicated that the introduction of alkali treatment provided a significant increase in the concentration of BG as compared to Examples 1-3 mainly due to a higher extent of protein removal. In addition, the viscosity of the beta-glucan concentrate was substantially higher.

### Example 5

The dried product from Screen-7 had a total mass of 5.2 g (13.0% of the raw-material bran weight). As summarized in Table 1, the beta-glucan concentration was 58.7% (w/w, dry basis) of the total mass of the dried product. Beta-glucan recovery was 44.7% of the total beta-glucan in the bran. Starch removal was 99.0%, protein removal was 97.9% and pentosan removal was 71.4%. The aqueous viscosity of the dried beta-glucan product (the solution prepared at 0.5% (w/w) beta-glucan concentration) was 135 centipoises at a shear rate of 129 s⁻¹. The final concentrated beta-glucan product was a free flowing powder with fresh grain odor and color.

Example 5 indicated that the effect of alkali treatment following protease and amylase treatment substantially increased the BG concentration (as compared to protease and amylase treatments alone—Example 2) within the product. In addition, the viscosity of the beta-glucan concentrate was substantially higher. Furthermore, the results of Example 5 when compared to those of Example 4, suggested that protease treatment has an advantage in terms of beta-glucan concentration.

### Example 6

The dried product from Screen-7 had a total mass of 5.7 g (14.3% of the raw-material bran weight). As summarized in Table 1, the beta-glucan concentration was 57.9% (w/w, dry basis) of the total mass of the dried product. Beta-glucan recovery was 48.7% of the total beta-glucan in the bran. Starch removal was 98.7%, protein removal was 97.4% and pentosan removal was 64.6%. The aqueous viscosity of the dried beta-glucan product (the solution prepared at 0.5% (w/w) beta-glucan concentration) was 121 centipoises at a shear rate of 129 s⁻¹. The final concentrated beta-glucan product was a free flowing powder with fresh grain odor and color.

Example 6 indicated that the effect of alkali treatment following xylanase and amylase treatments substantially increased the BG concentration within the product compared to the methodology of Example 3. In addition, the viscosity of the re-slurried product was substantially higher. Furthermore, the results of Example 6 when compared to those of Example 4, suggested that xylanase treatment has an advantage in terms of beta-glucan concentration.

### Other Experiments

Further experiments were conducted to evaluate the effect of different starting materials, the effect of pre- and post-wash steps and the order of enzyme treatment and alkali treatment.

The results of these experiments demonstrated that whole grain flours and endosperm flours when utilized as starting materials were effective in obtaining a concentrated BG product.

Further experiments were conducted to determine the importance of pre- and post-wash steps in achieving a concentrated BG product.

These experiments demonstrated that pre-washing steps are preferred but not essential to producing the concentrated BG product. In particular, pre-washing is particularly effective in removing a substantial amount of free starch granules from the original grain material/fiber residues. Experiments that did not include pre-washing required longer incubation times and/or greater concentrations of enzymes within the reaction mixtures. Such treatments would subsequently require additional post-washing steps to remove sugar residues from starch digestion that may otherwise not have been present had pre-washing been performed. Moreover, discoloration of the product may result from browning reactions of sugar residues, particularly if a subsequent treatment step was conducted at a higher temperature.

Further experiments were also conducted to determine the effectiveness of the order of enzyme and alkali treatments. These experiments determined that while it is preferred to conduct alkali treatment after an enzyme treatment, as this improved processing time by eliminating the need for an enzyme deactivation step at the end since the enzymes are inactivated during subsequent alkali treatment, a high concentration BG product could be produced by conducting alkali treatment before enzyme treatment.

Production Costs

Importantly, the production cost of producing high concentration BG can be significantly improved by using bran as the starting material compared to using an endosperm flour as the starting material as described in Applicant's co-pending applications. The production cost (Cost of Goods Sold-COGS) in accordance with the present methodologies depends on both fixed costs and variable costs in the production cycle. Generally, these costs include raw material costs for flour and ethanol, enzymes and alkali and other reagents together with plant operational costs.

From a strictly raw material perspective, under normal market conditions, the base price of whole oat flour is generally $1 X/kg (X=market price), bran is generally $2 X/kg, and air classified flour (endosperm flour) can be $5 X/kg (depending on the degree of processing). As a result, from a strictly raw material cost, whole flour would be the preferred starting material.

However, whole oat flour generally has considerably higher starch content and, as a result, requires substantially greater level of processing (including greater volumes of ethanol for washing). This can increase both fixed and variable costs within a plant with the result that total COGS in using whole oat flour will be higher when considering all costs contributing to final cost of production of a high concentration BG product.

In accordance with the present methodology, bran is the most cost effective feed stock taking into consideration the total COGS and the desired BG product.

### CONCLUSIONS

The results showed that the combination of utilizing bran as a starting material together with various enzyme treatment steps and an alkali treatment step substantially increased BG concentration within the final product as compared to the control experiment. Specifically, amylase, protease and/or xylanase treatment steps combined with alkali treatment increased BG concentration within the product. In addition, the products exhibited substantially higher viscosity compared to products prepared without alkali treatment indicating that the quality of BG product remained high.

Although the present invention has been described and illustrated with respect to preferred embodiments and preferred uses thereof, it is not to be so limited since modifications and changes can be made therein which are within the full, intended scope of the invention.

What is claimed is:

1. A method of concentrating beta-glucan (BG) from a grain material comprising the steps of:
a) mixing the grain material and a 40-100% (v/v) aqueous alcohol to form a grain/aqueous alcohol slurry and incubating the grain/aqueous alcohol slurry with a xylanase, amylase or protease and thereafter separating a first fiber residue;
b) mixing the first fiber residue with a 40-100% (v/v) aqueous alcohol at a high pH to form a second fiber residue/aqueous-alcohol slurry and thereafter separating a second fiber residue from the second fiber residue/aqueous-alcohol slurry;
c) mixing the second fiber residue with a 40-100% (v/v) aqueous alcohol to form a third fiber residue/aqueous-alcohol slurry and thereafter separating a final fiber residue from the third fiber residue/aqueous-alcohol slurry.

2. A method as in claim 1 wherein the final fiber residue has a BG concentration greater than 40% (dry basis).

3. A method as in claim 1 wherein step a) is repeated with a xylanase, amylase or protease before or after step b) wherein the xylanase, amylase or protease used in the repeated step a) is a different enzyme to that used in step a).

4. A method as in claim 1 further comprising a pre-wash step prior to step a), the pre-wash step comprising mixing the grain material with a 40-100% (v/v) aqueous alcohol to form a grain/aqueous alcohol slurry and separating a fiber residue from the grain/aqueous alcohol slurry as the starting grain material for step a).

5. A method as in claim 4 wherein the pre-wash step is repeated prior to step a).

6. A method as in claim 5 wherein the pre-wash step is repeated prior to step a).

7. A method as in claim 1 further comprising a post-wash step after step c) the post-wash step comprising mixing a separated fiber residue from step c) with a 40-100% (v/v) aqueous alcohol to form a further fiber residue/aqueous alcohol slurry and thereafter separating a further final fiber residue from the further fiber residue/aqueous alcohol slurry, wherein the further final fiber residue has a BG concentration greater than 40% (dry basis).

8. A method as in claim 7 wherein the post-wash step is repeated.

9. A method as in claim 1 wherein the grain material is bran.

10. A method as in claim 1 wherein the grain material is endosperm flour.

11. A method as in claim 1 wherein the grain material is whole grain flour.

12. A method as in claim 1 wherein the grain material is a combination of two or more of bran, endosperm flour and whole grain flour.

13. A method as in claim 1 wherein the grain material is barley.

14. A method as in claim 9 wherein the bran is an oat bran having a total beta-glucan content of at least 5.5% (dry weight basis).

15. A method as in claim 14 wherein prior to step a) the bran is subjected to a preliminary enrichment process wherein the total beta-glucan content is raised to at least 10% (by weight).

16. A method as in claim 15 wherein the preliminary enrichment process is an air classification process.

17. A method as in claim 1 wherein the BG concentration in the final fiber residue is greater than 45% (dry basis).

18. A method as in claim 1 wherein the BG concentration in the final fiber residue is greater than 50% (dry basis).

19. A method as in claim 1 wherein the BG concentration in the final fiber residue is greater than 55% (dry basis).

20. A method as in claim 1 wherein the final fiber residue has a protein concentration less than 3% (by weight).

21. A method as in claim 1 wherein the final fiber residue has a pentosan concentration less than 40% (by weight).

22. A method as in claim 1 wherein the viscosity of the final fiber residue when dissolved in water (0.5% w/w) is greater than 120 cP at a shear rate of 129 s⁻¹ at 20° C.

23. A method as in claim 1 wherein the aqueous alcohol is ethanol.

24. A method as in claim 1 wherein the order of steps a) and b) are reversed.

25. A method as in claim 23 wherein the ratio of grain material/fiber residue to aqueous alcohol is 1 part (by weight) of grain material/fiber residue to >2 parts (by volume) of 50% (v/v) aqueous ethanol.

26. A method of concentrating beta-glucan (BG) from bran comprising the steps of:
a) mixing bran having an initial beta-glucan content of at least 5% (dry weight basis) and a concentrated aqueous alcohol to form a first slurry;
b) separating a first fiber residue from the first slurry;
c) mixing the first fiber residue and a concentrated aqueous alcohol to form a second slurry;
d) separating a second fiber residue from the second slurry;
e) mixing the second fiber residue and a concentrated aqueous alcohol to form a third slurry;
f) separating a third fiber residue from the third slurry;
g) mixing the third fiber residue with concentrated aqueous alcohol and amylase to form a fourth fiber slurry and incubating the fourth fiber slurry for a time sufficient for the amylase to reduce starch content in the third fiber residue;
h) inactivating the amylase by adjusting the pH of the fourth fiber slurry to an acidic pH.
i) adjusting the pH of the fourth fiber slurry to a neutral pH and separating a fourth fiber residue from the fourth fiber slurry;
j) mixing the fourth fiber residue with concentrated aqueous alcohol to form a fifth fiber slurry;
k) adjusting the pH of the fifth fiber slurry to a pH>11 and incubating the fifth fiber slurry for a time sufficient to reduce protein content in the fourth fiber residue; add acid to achieve a neutral pH adjusting the pH of the fifth fiber slurry to a neutral pH;
l) separating a fifth fiber residue from the fifth fiber slurry;
m) mixing the fifth fiber residue with concentrated aqueous alcohol to form a sixth fiber slurry;
n) separating a sixth fiber residue from the sixth fiber slurry;
o) mixing the sixth fiber residue with concentrated aqueous alcohol to form a seventh fiber slurry;
p) separating a final fiber residue from the seventh fiber slurry wherein the final fiber residue has a BG content greater than 45% (dry basis).

27. A method as in claim 26 wherein the amylase is a heat-stable amylase and step g) is completed at 80° C.

28. A method as in claim 26 wherein step k) is completed at 60-80° C.

29. A method as in claim 26 wherein the concentrated aqueous alcohol is 50% (v/v).

30. A method as in claim 26 wherein the final fiber residue has a BG content greater than 50% (dry basis).

31. A method of concentrating beta-glucan (BG) from bran comprising the steps of:
a) mixing bran having an initial beta-glucan content of at least 5% (dry weight basis) and a concentrated aqueous alcohol to form a first slurry;
b) separating a first fiber residue from the first slurry;
c) mixing the first fiber residue and a concentrated aqueous alcohol to form a second slurry;
d) separating a second fiber residue from the second slurry;
e) mixing the second fiber residue and a concentrated aqueous alcohol to form a third slurry;
f) separating a third fiber residue from the third slurry;
g) mixing the third fiber residue with concentrated aqueous alcohol and protease to form a fourth fiber slurry and incubating the fourth fiber slurry for a time sufficient for the protease to reduce protein content in the third fiber residue;
h) separating a fourth fiber residue from the fourth fiber slurry;
i) mixing the fourth fiber residue with concentrated aqueous alcohol and amylase to form a fifth fiber slurry and incubating the fifth fiber slurry for a time sufficient for the amylase to reduce starch content in the fourth fiber residue;
j) inactivating the amylase by adjusting the pH of the fifth fiber slurry to an acidic pH;
k) adjusting the pH of the fifth fiber slurry to a neutral pH and separating a fifth fiber residue from the fifth fiber slurry;
l) mixing the fifth fiber residue with concentrated aqueous alcohol, adjusting the pH of the sixth fiber slurry to a pH>11 and incubating the sixth fiber slurry for a time sufficient to reduce protein content in the fifth fiber residue and adjusting the pH of the sixth fiber slurry to a neutral pH;
m) separating a sixth fiber residue from the sixth fiber slurry;
n) mixing the sixth fiber residue with concentrated aqueous alcohol to form a seventh fiber slurry;
o) separating a final fiber residue from the seventh fiber slurry wherein the final fiber residue has a final BG concentration greater than 45% (dry basis).

32. A method as in claim 31 wherein the amylase is a heat-stable amylase and step g) is completed at 80° C.

33. A method as in claim 31 wherein step i) is completed at 60-80° C.

34. A method as in claim 31 wherein the concentrated alcohol is 50% (v/v).

35. A method as in claim 31 wherein the final BG concentration is greater than 50% (dry basis).

36. A method as in claim 31 wherein the final BG concentration is greater than 55% (dry basis).

37. A method of concentrating beta-glucan (BG) from bran comprising the steps of:
a) mixing bran having an initial beta-glucan content of at least 5% (dry weight basis) and a concentrated aqueous alcohol to form a first slurry;
b) separating a first fiber residue from the first slurry;
c) mixing the first fiber residue and a concentrated aqueous alcohol to form a second slurry;
d) separating a second fiber residue from the second slurry;
e) mixing the second fiber residue and a concentrated aqueous alcohol to form a third slurry;
f) separating a third fiber residue from the third slurry;
g) mixing the third fiber residue with concentrated aqueous alcohol and xylanase to form a fourth fiber slurry and incubating the fourth fiber slurry for a time sufficient for the xylanase to reduce xylan content in the third fiber residue;
h) separating a fourth fiber residue from the fourth fiber slurry
i) mixing the fourth fiber residue with concentrated aqueous alcohol and amylase to form a fifth fiber slurry and incubating the fifth fiber slurry for a time sufficient for the amylase to reduce starch content in the fourth fiber residue;
j) inactivating the amylase by adjusting the pH of the fifth fiber slurry to an acidic pH;
k) adjusting the pH of the fifth fiber slurry to a neutral pH and separating a fifth fiber residue from the fifth fiber slurry;
l) mixing the fifth fiber residue with concentrated aqueous alcohol to form a sixth fiber slurry adjusting the pH of the sixth fiber slurry to a pH>11 and incubating the sixth fiber slurry for a time sufficient to reduce protein content in the fifth fiber residue; adjusting the pH of the sixth fiber slurry to a neutral pH
m) separating a sixth fiber residue from the sixth fiber slurry;
n) mixing the sixth fiber residue with concentrated aqueous alcohol to form a seventh fiber slurry;
o) separating a final fiber residue from the seventh fiber slurry wherein the final fiber residue has a final BG concentration greater than 45% (dry basis).

38. A method as in claim 37 wherein the amylase is a heat-stable amylase and step g) is completed at 80° C.

39. A method as in claim 37 wherein step i) is completed at 60-80° C.

40. A method as in claim 37 wherein the concentrated alcohol is 50% (v/v).

41. A method as in claim 37 wherein the final BG concentration is greater than 50% (dry basis).

42. A method as in claim 37 wherein the final BG concentration is greater than 55% (dry basis).
